(19) United States
(12) Patent Application Publication
(10) Pub. No.: US 2018/0172930 A1
(43) Pub. Date: Jun. 21, 2018

(54) OPTICAL MODULE

(71) Applicant: FUJITSU COMPONENT LIMITED, Tokyo (JP)

(72) Inventors: Mitsuki Kanda, Tokyo (JP); Takatoshi Yagisawa, Tokyo (JP)

(21) Appl. No.: 15/800,513

(22) Filed: Nov. 1, 2017

(30) Foreign Application Priority Data
Dec. 15, 2016 (JP) 2016-243545

(51) Int. Cl. G02B 6/42; H04B 10/50

(52) U.S. Cl. CPC G02B 6/4266; H04B 10/503; G02B 6/4269

(57) ABSTRACT

An optical module includes a light-emitting element, an optical waveguide configured to transmit light emitted by the light-emitting element, a temperature sensor, a housing that houses the light-emitting element and the temperature sensor, a first radiator disposed between the light-emitting element and the housing, and a second radiator disposed between the temperature sensor and the housing.

### CROSS-REFERENCE TO RELATED APPLICATION

The present application is based upon and claims the benefit of priority of Japanese Patent Application No. 2016-243545, filed on Dec. 15, 2016, the entire contents of which are incorporated herein by reference.

### BACKGROUND OF THE INVENTION

### 1. Field of the Invention

An aspect of this disclosure relates to an optical module.

### 2. Description of the Related Art

Electric cables made of, for example, copper have been used for communications performed by supercomputers and high-end servers via high-speed interfaces. However, optical communication is becoming popular to achieve high-speed signal transmission and to increase the transmission distance.

Next generation interfaces with a long transmission distance of dozens of meters employ optical communication technologies, and use optical modules to connect optical cables to servers and convert electric signals into optical signals. An optical module converts an optical signal from an optical cable into an electric signal, outputs the electric signal to a server, converts an electric signal from the server into an optical signal, and outputs the optical signal to the optical cable.

An optical module includes, in a housing, a light-emitting element for converting an electric signal into an optical signal, a light-receiving element for converting an optical signal into an electric signal, a driving integrated circuit (IC) for driving the light-emitting element, and a trans-impedance amplifier (TIA) for converting an electric current into a voltage. The light-emitting element, the light-receiving element, the driving IC, and the TIA are mounted on a board. The light-emitting element and the light-receiving element are connected to a ferrule such as a lens ferrule via an optical waveguide (see, for example, Japanese Laid-Open Patent Publication No. 2013-069883 and Japanese Laid-Open Patent Publication No. 2015-022129).

Because a large amount of electric current flows into a light-emitting element such as a vertical cavity surface emitting laser (VCSEL) in an optical module, the temperature of the light-emitting element tends to become high, which results in a decrease in the power of the light-emitting element. When the power of the light-emitting element decreases, normal optical communication may be prevented. To prevent this problem, when the temperature of the light-emitting element becomes high, the amount of electric current supplied to the light-emitting element is reduced.

However, because it is difficult to accurately measure the temperature of a light-emitting element, it is difficult to control the light-emitting element to emit a light beam with desired intensity and to properly perform optical communication.

For the above reasons, there is a demand for an optical module configured such that a light-emitting element can emit a laser beam with desired intensity even when the temperature of the light-emitting element becomes high.

### SUMMARY OF THE INVENTION

In an aspect of this disclosure, there is provided an optical module including a light-emitting element, an optical waveguide configured to transmit light emitted by the light-emitting element, a temperature sensor, a housing that houses the light-emitting element and the temperature sensor, a first radiator disposed between the light-emitting element and the housing, and a second radiator disposed between the temperature sensor and the housing.

### BRIEF DESCRIPTION OF THE DRAWINGS

FIG. 1 is an exploded perspective view of an optical module of a first embodiment;

FIG. 2 is a top view of a part of the optical module of the first embodiment;

FIGS. 3A and 3B are cross-sectional views of the optical module of the first embodiment;

FIGS. 4A and 4B are cross-sectional views of an optical module of a comparative example;

FIGS. 5A and 5B are cross-sectional views of an optical module of a comparative example;

FIG. 6 is a cross-sectional view of an optical module of a second embodiment;

FIGS. 7A and 7B are cross-sectional views of an optical module of a third embodiment; and

FIGS. 8A and 8B are cross-sectional views of an optical module of a variation of the third embodiment.

### DESCRIPTION OF EMBODIMENTS

Embodiments of the present invention are described below. The same reference number is assigned to the same component, and repeated descriptions of the same component are omitted.

### First Embodiment

<Optical Module>

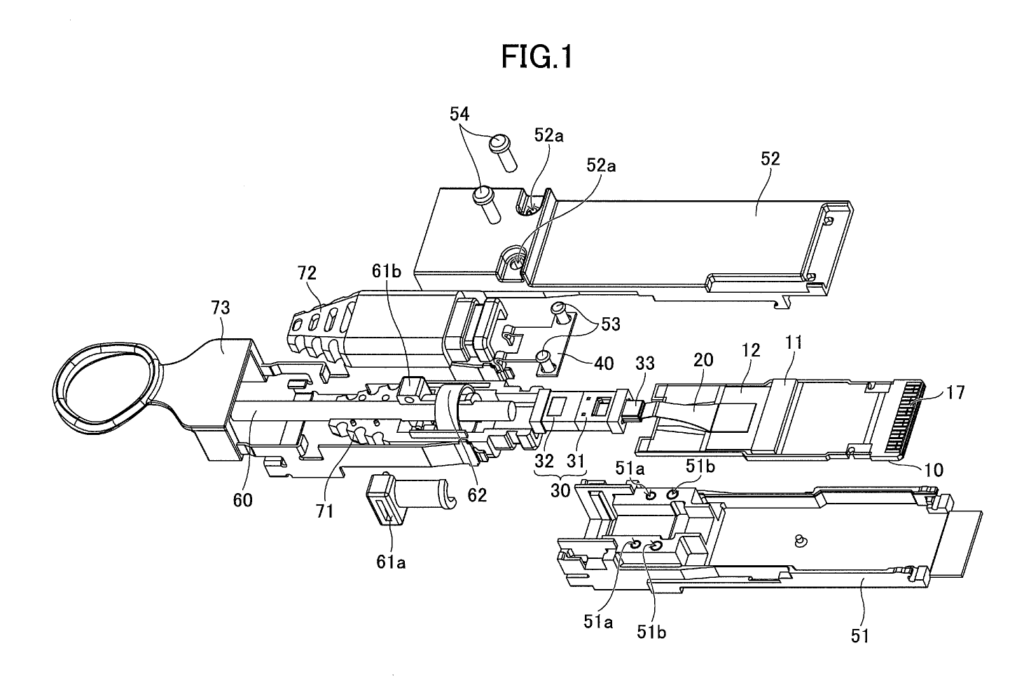

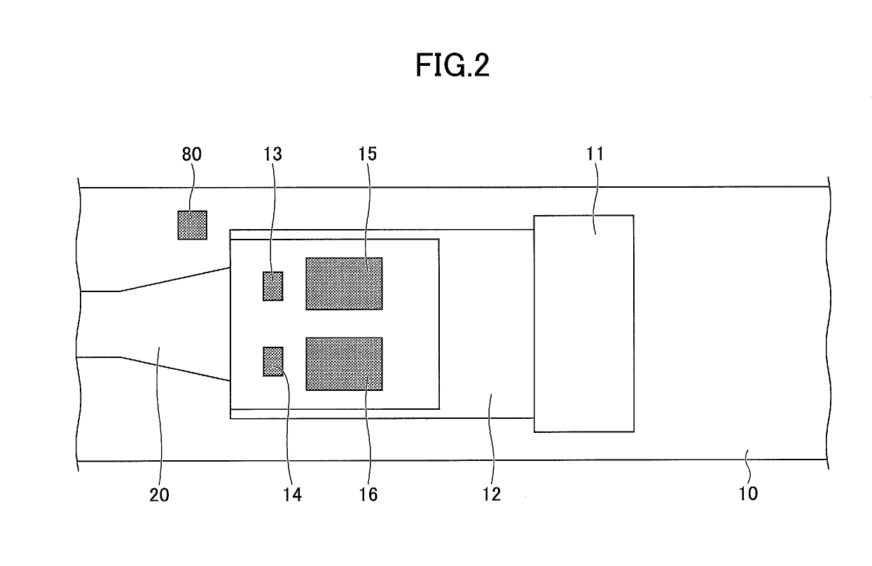

An optical module according to a first embodiment is described with reference to FIGS. 1 and 2. FIG. 1 is an exploded perspective view of the optical module of the first embodiment, and FIG. 2 is a top view of a part of the optical module.

As illustrated in FIG. 1, the optical module includes a circuit board 10, an optical waveguide 20, an optical connector 30, and a clip that are housed in a housing formed by a lower housing 51 and an upper housing 52. An optical cable 60 is connected to the optical module. A part of the optical cable 60 is covered by the housing. The board 10 includes a flexible printed-circuit (FPC) connector 11 to which an FPC board 12 is connected, and a terminal 17 for external connection.

As illustrated in FIG. 2, the FPC board 12 includes a light-emitting element 13 such as a VCSEL for converting an electric signal into an optical signal and outputting the optical signal, and a light-receiving element 14 such as a photodiode for converting an optical signal into an electric signal. The board 10 also includes a driving integrated circuit (IC) 15 for driving the light-emitting element 13, and a trans-impedance amplifier (TIA) 16 for converting an electric current output from the light-receiving element 14 into a voltage. The light-emitting element 13 and the light-receiving element 14 are mounted on the FPC board 12 in a “face-down” orientation. The board 10 also includes a temperature sensor 80.

The optical waveguide 20 is formed like a flexible sheet, and includes multiple cores surrounded by clads. Light entering the optical waveguide 20 propagates through the cores.

The optical connector 30 includes a lens ferrule 31 and a mechanically transferable (MT) ferrule 32 that are connected to each other. The optical waveguide 20 is connected to the lens ferrule 31, and the junction between the optical waveguide 20 and the lens ferrule 31 is protected by a ferrule boot 33. The clip 40 is fixed to the lower housing 51 with screws 53 that are passed through screw holes formed in the clip 40 and screwed into screw holes 51a formed in the lower housing 51.

Sleeves 61a and 61b are fixed by a crimp ring 62 to the optical cable 60. A portion of the optical cable 60 to which the sleeves 61a and 61b are fixed is covered by upper and lower cable boots 71 and 72, and a pull-tab/latch part 73 is attached to the cable boots 71 and 72.

The optical connector 30 is fixed via the clip 40 to the lower housing 51, the upper housing 52 is placed on the lower housing 51 on which the board 10 is placed, and screws 54 are screwed into screw holes 52a of the upper housing 52 and screw holes 51b of the lower housing 51 to fix the upper housing 52 to the lower housing 51. The lower housing 51 and the upper housing 52 are formed of a metal such as aluminum, and have a relatively-high thermal conductivity.

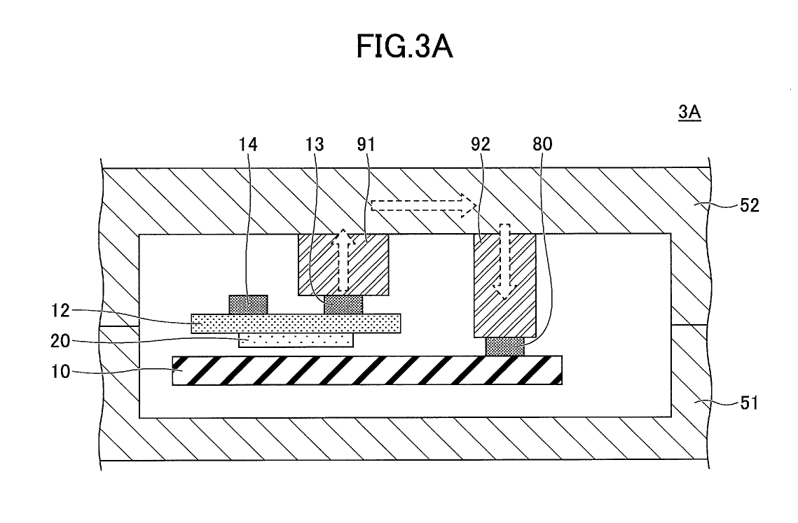

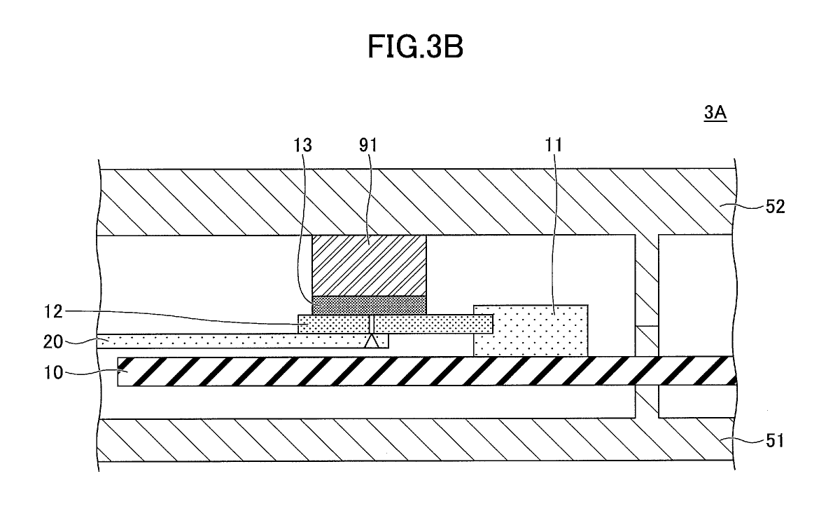

FIG. 3A is a cross-sectional view of an optical module 3A of the first embodiment taken along a line that is orthogonal to the longitudinal direction of the optical module 3A, and FIG. 3B is a cross-sectional view of the optical module 3A taken along a line that is parallel to the longitudinal direction of the optical module 3A. As illustrated in FIGS. 3A and 3B, the optical module 3A includes a first radiator 91 provided between the light-emitting element 13 on the FPC board 12 and the upper housing 52, and a second radiator 92 provided between the temperature sensor 80 and the upper housing 52.

In the optical module 3A, one surface of the first radiator 91 is in contact with the light-emitting element 13, and another surface of the first radiator 91 is in contact with the upper housing 52. Also, one surface of the second radiator 92 is in contact with the temperature sensor 80, and another surface of the second radiator 92 is in contact with the upper housing 52. With this configuration, as indicated by dotted-line arrows, heat generated in the light-emitting element 13 flows through the first radiator 91, the upper housing 52, and the second radiator 92 in this order, and is transferred to the temperature sensor 80.

The first radiator 91 and the second radiator 92 are, for example, radiating sheets, and formed of a material that has insulating properties and a relatively-high thermal conductivity. Examples of materials of the first radiator 91 and the second radiator 92 include silicon rubber, silicon grease, and an epoxy resin including an alumina filler.

### <Simulations>

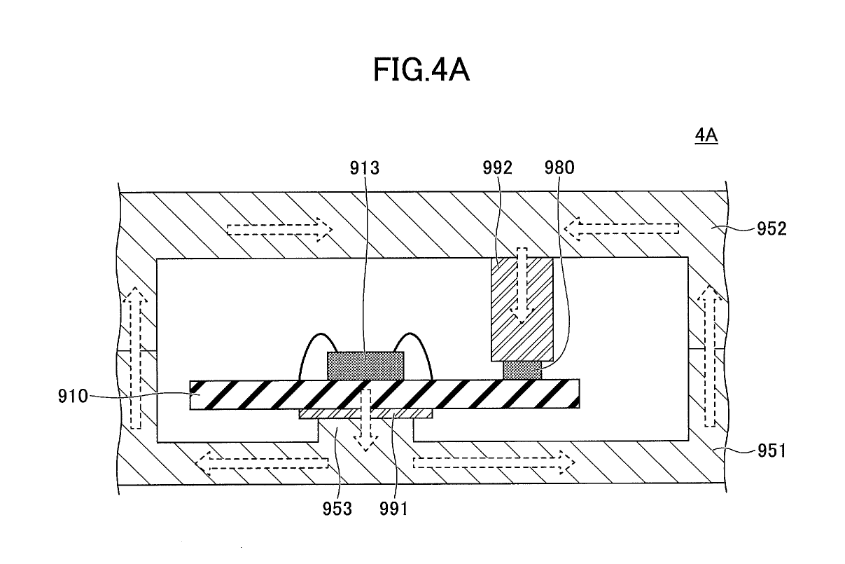

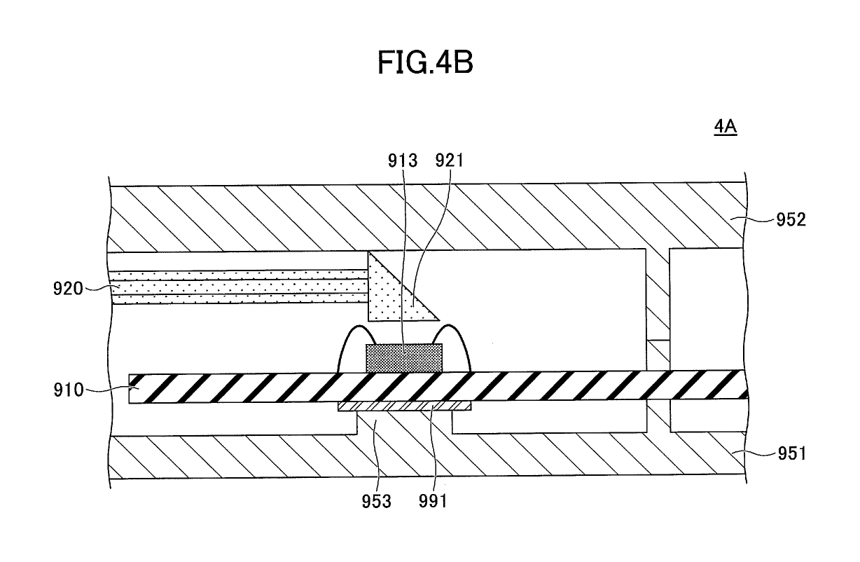

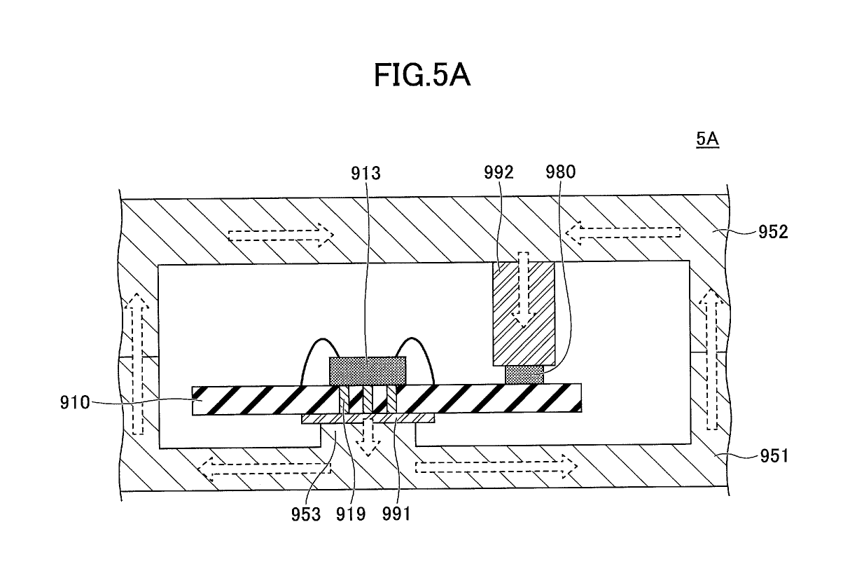

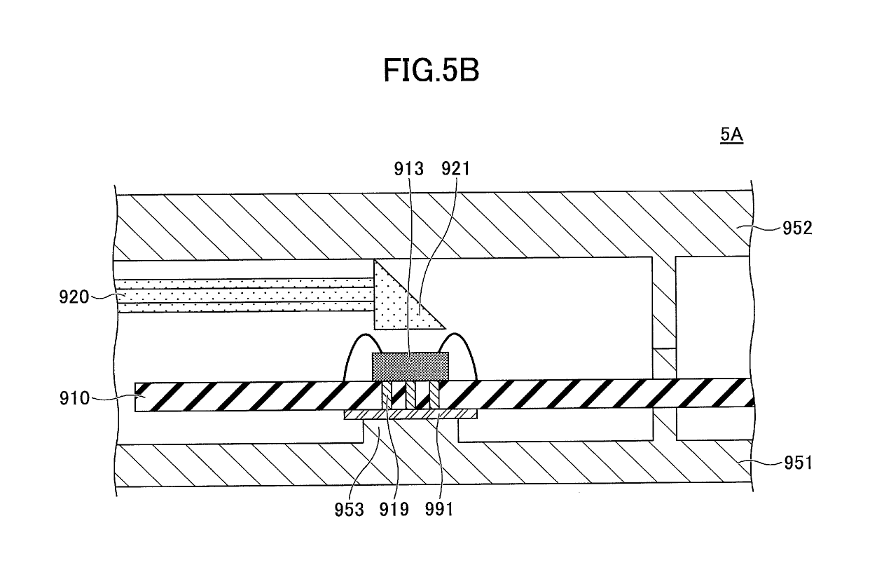

Next, results of simulations of optical modules are described. Simulations of the optical module 3A of the first embodiment illustrated in FIGS. 3A and 3B, an optical module 4A of a comparative example illustrated in FIGS. 4A and 4B, and an optical module 5A of a comparative example illustrated in FIGS. 5A and 5B were performed.

FIG. 4A is a cross-sectional view of the optical module 4A taken along a line that is orthogonal to the longitudinal direction of the optical module 4A, and FIG. 4B is a cross-sectional view of the optical module 4A taken along a line that is parallel to the longitudinal direction of the optical module 4A. As illustrated in FIGS. 4A and 4B, the optical module 4A includes a light-emitting element 913 such as a VCSEL and a temperature sensor 980 that are provided on a circuit board 910.

The light-emitting element 913 is mounted on the circuit board 910 in a “face-up” orientation. A mirror 921 and an optical waveguide 920 are provided above the light-emitting element 913. A laser beam emitted from the light-emitting element 913 is reflected by the mirror 921, and enters the optical waveguide 920. The circuit board 910 and the optical waveguide 920 are housed in a housing formed by a lower housing 951 and an upper housing 952. The lower housing 951 and the upper housing 952 are formed of a metal.

In the optical module 4A illustrated in FIGS. 4A and 4B, a protrusion 953 is formed on an inner surface of the lower housing 951 to protrude toward a surface of the circuit board 910 that is opposite the surface on which the limit-emitting element 913 is formed. A radiating sheet 991 is provided between the circuit board 910 and the protrusion 953 of the lower housing 951, and a radiating sheet 992 is provided between the upper housing 952 and the temperature sensor 980. In the optical module 4A, as indicated by dotted-line arrows, heat generated in the light-emitting element 913 flows through the circuit board 910, the radiating sheet 991, the protrusion 953, the lower housing 951, the upper housing 952, and the radiating sheet 992 in this order, and is transferred to the temperature sensor 980.

FIG. 5A is a cross-sectional view of the optical module 5A taken along a line that is orthogonal to the longitudinal direction of the optical module 5A, and FIG. 5B is a cross-sectional view of the optical module 5A taken along a line that is parallel to the longitudinal direction of the optical module 5A. In the optical module 5A illustrated in FIGS. 5A and 5B, nine vias 919 are formed through the circuit board 910 near an area of the circuit board 910 where the light-emitting element 913 is disposed.

The vias 919 are formed in the circuit board 910 to reduce the difference between a temperature measured by the temperature sensor 980 and a temperature of the light-emitting element 913. The size of each via 919 is 0.3 mm×0.3 mm. Heat generated in the light-emitting element 913 flows in the directions indicated by dotted-line arrows, and is transferred to the temperature sensor 980.

In the simulations, the temperature of the light-emitting element and the temperature of an upper part of the housing in each of the optical modules 3A, 4A, and 5A were calculated based on an assumption that the light-emitting element was driven at 0.008 W. Table 1 illustrates the results of the simulations. In the present application, because the distance between the upper part of the housing and the temperature sensor is relatively short and the temperature of the upper part of the housing can be considered to be substantially the same as the temperature measured by the temperature sensor, the temperature of the upper part of the housing is referred to as the temperature measured by the temperature sensor.

TABLE 1

| | Light- | | |
|---|---|---|---|
| | Emitting | Temperature | |
| | Element | Sensor | Difference |
| Optical | 76.8° C. | 70.5° C. | 6.3° C. |
| Module 3A | | | |
| Optical | 86.3° C. | 75.2° C. | 11.1° C. |
| Module 4A | | | |
| Optical | 82.3° C. | 74.5° C. | 7.8° C. |
| Module 5A | | | |

In the case where the light-emitting element 13 of the optical module 3A of the first embodiment illustrated in FIGS. 3A and 3B is driven, the temperature of the light-emitting element 13 is 76.8° C., the temperature measured by the temperature sensor 80 is 70.5° C., and the difference between the temperature of the light-emitting element 13 and the temperature measured by the temperature sensor 80 is 6.3° C.

In the case where the light-emitting element 913 of the optical module 4A illustrated in FIGS. 4A and 4B is driven, the temperature of the light-emitting element 913 is 86.3° C., the temperature measured by the temperature sensor 980 is 75.2° C., and the difference between the temperature of the light-emitting element 913 and the temperature measured by the temperature sensor 980 is 11.1° C.

In the case where the light-emitting element 913 of the optical module 5A illustrated in FIGS. 5A and 5B is driven, the temperature of the light-emitting element 913 is 82.3° C., the temperature measured by the temperature sensor 980 is 74.5° C., and the difference between the temperature of the light-emitting element 913 and the temperature measured by the temperature sensor 980 is 7.8° C.

As the above results indicate, compared with the configurations of the optical modules 4A and 5A, the configuration of the optical module 3A of the first embodiment can reduce the difference between the temperature of the light-emitting element and the temperature measured by the temperature sensor, and makes it possible to properly control the amount of electric current supplied to the light-emitting element.

When the difference between the temperature of the light-emitting element and the temperature measured by the temperature sensor is large, even if an amount of electric current corresponding to the temperature measured by the temperature sensor is supplied to the light-emitting element, the amount of supplied electric current may be greater than or less than necessary, and a laser beam with desired intensity may not be obtained. In contrast, when the difference between the temperature of the light-emitting element and the temperature measured by the temperature sensor is small, it is possible to cause the light-emitting element to emit a laser beam with intensity close to desired intensity by supplying an amount of electric current corresponding to the temperature measured by the temperature sensor to the light-emitting element. The amount of electric current supplied to the light-emitting element is controlled by a driving IC for driving the light-emitting element based on the temperature measured by the temperature sensor.

With the optical module of the first embodiment, because the temperature measured by the temperature sensor 80 is close to the temperature of the light-emitting element 13, it is possible to control the light-emitting element 13 by the driving IC 15 to emit a laser beam with intensity close to desired intensity and to perform stable optical communications.

It is supposed that the difference between the temperature of the light-emitting element and the temperature measured by the temperature sensor in the optical module 3A of the first embodiment becomes smaller than the difference in the optical modules 4A and 5B because the thermal path between the light-emitting element and the temperature sensor in the optical module 3A is shorter than that in the optical modules 4A and 5A.

In the optical module, the temperatures of the light-emitting element 13 and the driving IC 15 for driving the light-emitting element 13 tend to become relatively high. In the first embodiment, although the first radiator 91 is provided on the light-emitting element 13, no radiator is provided on the light-receiving element 14 and the TIA 16. Providing the first radiator 91 also on the light-receiving element 14 and the TIA 16 is not preferable because heat is transferred via the first radiator 91 even to the light-receiving element 14 and the TIA 16 whose temperatures do not become very high. Also, if the first radiator 91 is provided also on the light-receiving element 14 and the TIA 16, the area of the first radiator 91 increases, and heat generated in the light-emitting element 13 diffuses over a large area. As a result, it may become difficult to accurately measure the temperature of the light-emitting element 13 by the temperature sensor 80. For the above reasons, in the optical module of the first embodiment, the first radiator 91 is provided on the light-emitting element 13 but not provided on the light-receiving element 14 and the TIA 16.

The first radiator 91 may be provided not only on the light-emitting element 13 but also on the driving IC 15. However, in a case where the temperature of the driving IC 15 becomes higher than the temperature of the light-emitting element 13, the first radiator 91 is preferably not provided on the driving IC 15. If the first radiator 91 is provided also on the driving IC 15 in such a case, heat generated in the driving IC 15 is transferred to the light-emitting element 13 and increases the temperature of the light-emitting element 13, and heat generated in ICs including the driving IC 15 is transferred to the temperature sensor 80. As a result, it becomes difficult to measure the temperature of the light-emitting element 13.

### Second Embodiment

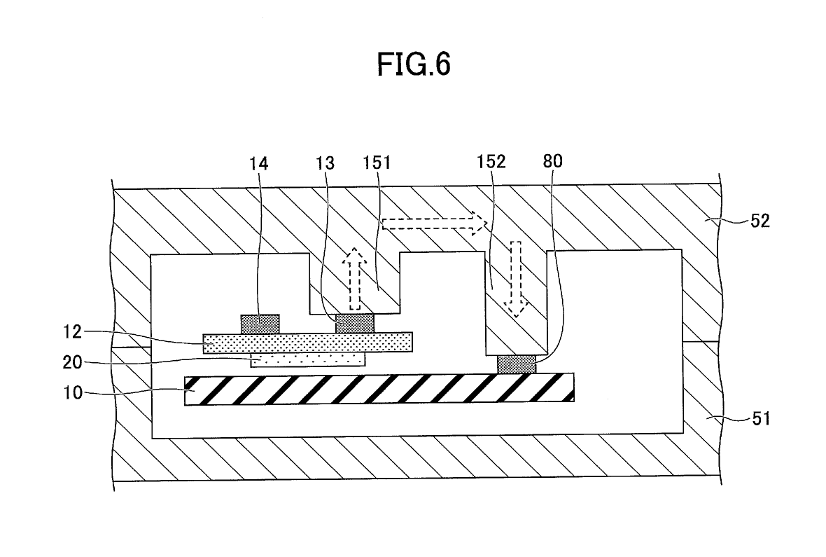

Next, a second embodiment is described. In an optical module of the second embodiment, as illustrated in FIG. 6, a first protrusion 151 and a second protrusion 152 are formed on an inner surface of the upper housing 52. The first protrusion 151 and the second protrusion 152 are parts of the upper housing 52. Because the upper housing 52 is formed of a metal with a high thermal conductivity such as aluminum, similarly to the first embodiment, this configuration makes it possible to make the temperature measured by the temperature sensor 80 close to the temperature of the light-emitting element 13. In the second embodiment, the first protrusion 151 is in contact with the light-emitting element 13, and the second protrusion 152 is in contact with the temperature sensor 80.

Other components and configurations of the optical module of the second embodiment are substantially the same as those described in the first embodiment.

### Third Embodiment

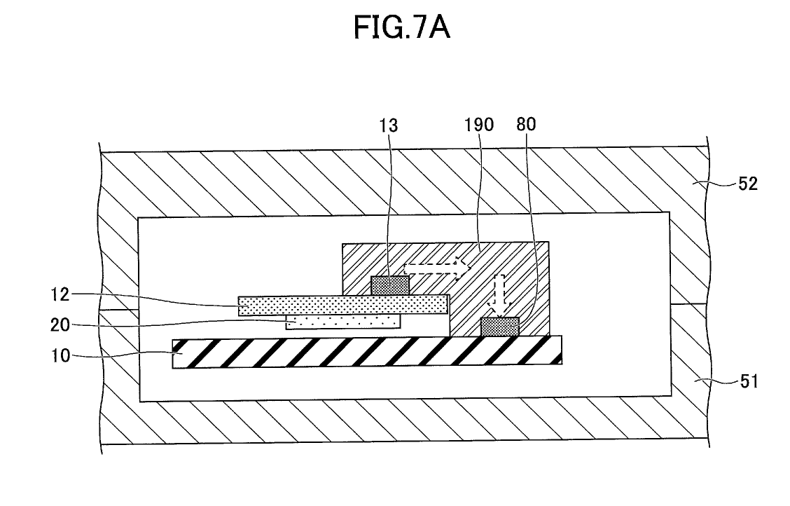

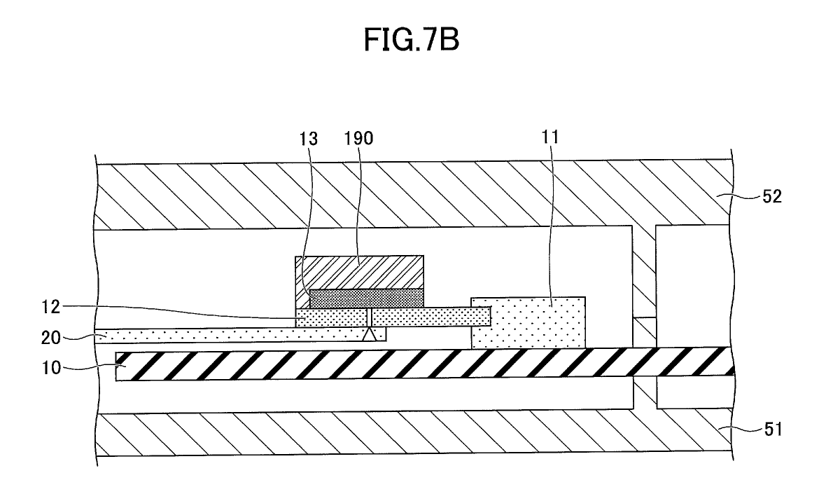

Next, a third embodiment is described. FIG. 7A is a cross-sectional view of an optical module of the third embodiment taken along a line that is orthogonal to the longitudinal direction of the optical module, and FIG. 7B is a cross-sectional view of the optical module taken along a line that is parallel to the longitudinal direction of the optical module.

In the optical module of the third embodiment, as illustrated in FIGS. 7A and 7B, the light-emitting element 13 and the temperature sensor 80 are covered by a radiator 190.

With the configuration where the light-emitting element 13 and the temperature sensor 80 are covered by the radiator 190, as indicated by dotted-line arrows, heat generated in the light-emitting element 13 flows through the radiator 190 and is transferred to the temperature sensor 80. This configuration also makes it possible to make the temperature measured by the temperature sensor close to the temperature of the light-emitting element 13. The radiator 190 is a radiating sheet, and may be formed of a material similar to the material of the first and second radiators 91 and 92 described in the first embodiment.

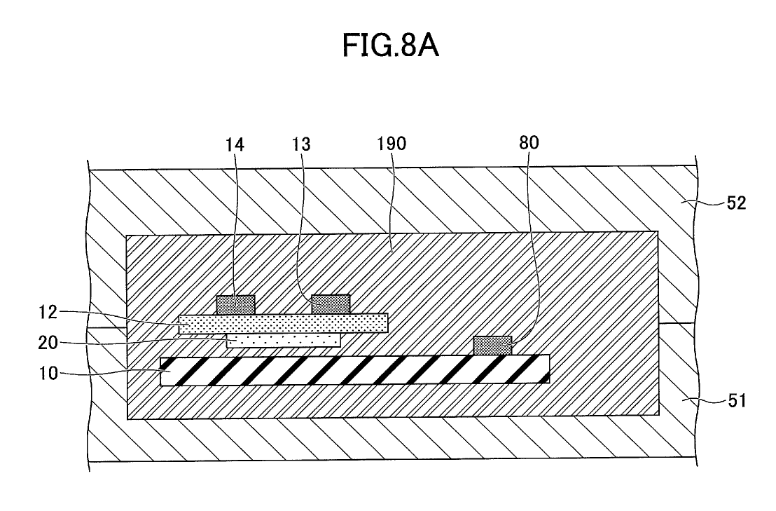

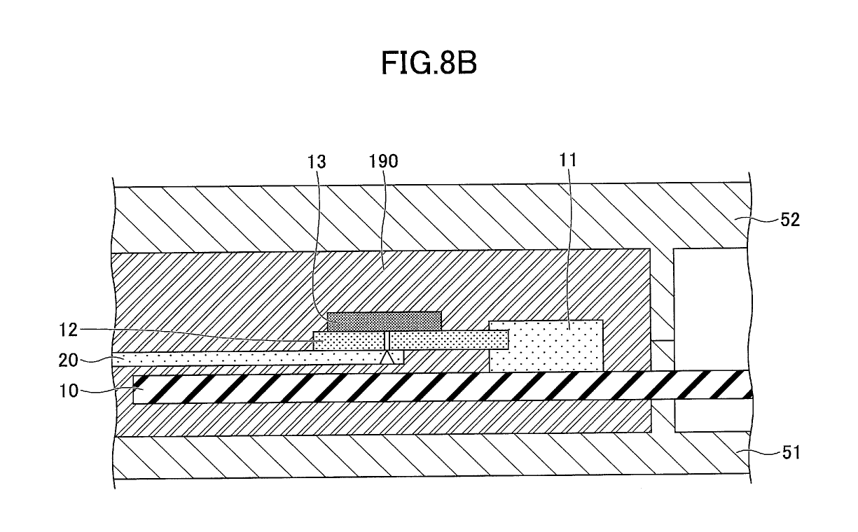

In an optical module according to a variation of the third embodiment, as illustrated in FIGS. 8A and 8B, an internal space of the housing surrounded by the upper housing 52 and the lower housing 51 may be filled with a radiator 190 formed of, for example, a resin with a high thermal conductivity. With this configuration, heat generated in the light-emitting element 13 and the driving IC 15 is transferred via the radiator 190 to the upper housing 52 and the lower housing 51, and is effectively released. FIG. 8A is a cross-sectional view of the optical module taken along a line that is orthogonal to the longitudinal direction of the optical module, and FIG. 8B is a cross-sectional view of the optical module taken along a line that is parallel to the longitudinal direction of the optical module.

Other components and configurations of the optical module of the third embodiment are substantially the same as those described in the first embodiment.

An aspect of this disclosure provides an optical module configured such that a light-emitting element can emit a laser beam with intensity close to desired intensity even when the temperature of the light-emitting element becomes high.

Optical modules according to embodiments of the present invention are described above. However, the present invention is not limited to the specifically disclosed embodiments, and variations and modifications may be made without departing from the scope of the present invention.

What is claimed is:

1. An optical module, comprising:
a light-emitting element;
an optical waveguide configured to transmit light emitted by the light-emitting element;
a temperature sensor;
a housing that houses the light-emitting element and the temperature sensor;
a first radiator disposed between the light-emitting element and the housing; and
a second radiator disposed between the temperature sensor and the housing.

2. The optical module as claimed in claim 1, further comprising:
a driving element configured to drive the light-emitting element,
wherein the driving element is configured to control an electric current supplied to the light-emitting element based on a temperature measured by the temperature sensor.

3. An optical module, comprising:
a light-emitting element;
an optical waveguide configured to transmit light emitted by the light-emitting element;
a temperature sensor;
a housing that houses the light-emitting element and the temperature sensor;
a first protrusion that is formed on an inner surface of the housing and in contact with the light-emitting element; and
a second protrusion formed on the inner surface of the housing and in contact with the temperature sensor.

4. The optical module as claimed in claim 3, further comprising:
a driving element configured to drive the light-emitting element,
wherein the driving element is configured to control an electric current supplied to the light-emitting element based on a temperature measured by the temperature sensor.

5. An optical module, comprising:
a light-emitting element;
an optical waveguide configured to transmit light emitted by the light-emitting element;
a temperature sensor;
a housing that houses the light-emitting element and the temperature sensor; and
a radiator that covers the light-emitting element and the temperature sensor.

6. The optical module as claimed in claim 5, wherein an internal space of the housing is filled with the radiator.

7. The optical module as claimed in claim 5, further comprising:
a driving element configured to drive the light-emitting element,
wherein the driving element is configured to control an electric current supplied to the light-emitting element based on a temperature measured by the temperature sensor.
